(19) United States
(12) Patent Application Publication
(10) Pub. No.: US 2004/0081882 A1
(43) Pub. Date: Apr. 29, 2004

(54) Electrical tool system with battery pack

(76) Inventor: Rainer Ontl, Landsberg am Lech (DE)

Correspondence Address: SIDLEY AUSTIN BROWN & WOOD LLP, 787 Seventh Avenue, New York, NY, 10019, US

(21) Appl. No.: 10/623,977

(22) Filed: Jul. 21, 2003

(30) Foreign Application Priority Data
Jul. 22, 2002 (DE) 102 33 162.6

(51) Int. Cl. H01M 2/10; H01M 10/46

(52) U.S. Cl. 429/96; 320/162; 320/112

(57) ABSTRACT

An electrical tool system comprising a battery pack (2) having a battery voltage; a charging unit (3) having a charging voltage for charging the battery pack (2) and a hand-guided electrical tool (1), in particular a screwdriver, and having an attachment system (8) disposed on the housing (4) and on the battery pack (2) for detachable attachment of the battery pack (2) to the housing (4). The attachment system (8) on the housing (4) includes a receiving member (11) and an engaging member (12), on the battery pack (2), that can be brought into engagement with the receiving member (11). The engaging member and the receiving member each comprise a key device, which has a topography and a first blocking means, so that in the interlocked condition, the battery pack (2) and the electrical motor (6) cooperate, if the battery voltage is equal to or lower than the nominal voltage. Such an arrangement create an electrical tool system which enables the use of battery packs (2) with different battery voltages with an electrical tool (1) and prevents overload of the battery pack (2) and the electrical tool (1).

### BACKGROUND OF THE INVENTION

The invention relates to an electrical tool system including a battery pack with battery voltage, a charging unit with charging voltage for charging the battery pack and a hand-guided electrical tool such as a drill, screw driver or the like, having an electrical motor that can be operated at a nominal voltage by the battery pack, a housing and an attachment system on the housing and the battery pack for removable attachment of the battery pack on the housing. The attachment system has a receiving member, on one part, and an engagement member, on the other part, that can be brought into engagement with the receiving part. The housing has a contact means and the battery pack has a corresponding counter contact.

Electrical tool systems of the type described above having an electrical tool operated by a battery pack, such as a drill, screwdriver or the like are used for work independent of electrical supply lines. The electrical tool system further has a charging unit that electrically recharges the battery.

DE 4 402 355 C2 discloses an electrical tool system including a battery pack with battery voltage, a charging unit with a charging voltage for charging the battery pack and a hand-guided electrical tool. The electrical tool has an electrical motor that can be driven using a nominal voltage from the battery pack, a housing and an attachment system arranged on the housing and on the battery pack. The attachment system is used for removable attachment of the battery pack on the housing. The attachment system has a receiving member, on the one part, and an engaging member, on the other part, that can be brought to engage in the receiving member. The housing has a contact member and the battery pack has a corresponding counter contact member. The battery pack has a formal connecting member configured as an insert member, which can be installed in a recess disposed on the housing, if the nominal voltage of the electrical motor is equal to the battery voltage of the battery pack.

The advantage of this known solution is that only battery packs with the battery voltage corresponding to the nominal voltage of the electrical motor can cooperate with the electrical motor. In this manner, on the one hand, damage to the electrical motor caused by a battery pack having a battery voltage higher than that of the nominal voltage can be prevented and, on the other hand, optimal performance of the electrical device is possible, since the battery voltage is not lower than the nominal voltage of the electrical motor.

The drawback in the known solution is that the formal connecting member is configured as a separate part and consequently has a negative effect on the economics of manufacturing the electrical tool system.

### SUMMARY OF THE INVENTION

The object of the present invention is to provide an electrical tool system with an electrical tool that can be driven by a battery back and a charging unit for charging the battery pack. The system enables use of battery packs with different battery voltages with one electrical tool, on the one hand, and prevents an overload of the battery pack and the electrical tool, on the other hand. According to the invention, this object is achieved in that the engaging member and the receiving member have a key device, which has a topography such as a profile, on one part, and a counter-topography, such as a counter-profile for the topography, on the other part, wherein each nominal voltage of a system component is associated with a specific topography and complementary counter-topography.

Since each nominal voltage is associated with a topography and the complementary counter-topography, for example, the use of several electrical devices with one battery pack is possible, if the corresponding topography matches the complementary topography.

Advantageously, the attachment system includes a blocking means, which prevents locking of the attachment system between the electrical tool and the battery pack, if the nominal voltage of the electrical tool is lower than the battery voltage of the battery pack. Such a system, assures that neither the battery pack nor the electrical motor is damaged or even destroyed by excessive power consumption or power output, on the one hand, and thus assures that one battery pack can be used in several electrical devices having an electrical motor with the same or higher nominal voltage, on the other hand. In addition, such a system makes the economical manufacture of the electrical tool system possible since the attachment system, in particular the receiving member and the engaging member, have the key means and are easy to handle by the user. The blocking means interrupts or prevents the electrical flow between the battery pack and the electrical motor if the battery voltage is the equal to or lower than the nominal voltage. The nominal voltage of the electrical motor must be equivalent to the operating voltage. The blocking means can be configured to be electrical as well as mechanical.

Preferably, the battery pack has the topography for ‘coding’ the battery voltage by the topography to assure that the electrical device and the charging device cooperate with a matching battery pack.

Preferably, the battery pack has at least one carrier having the topography to enable economical manufacture of the battery pack.

Advantageously, the topography includes the length of the carrier or carriers. The higher the battery voltage the longer the carrier or carriers are configured. Naturally, the topography could, for example, include the width of the carrier or carriers.

Advantageously, the electrical tool has the first blocking means to prevent the cooperation of a battery pack having a battery voltage that is excessively high. The blocking means interrupts and/or prevents a current flow between the battery pack and at least the electrical motor. The embodiment of the blocking means can be configured both electronically and mechanically as a current cutoff, for example.

The blocking means advantageously has at least one stop and thereby makes possible economical manufacture of the electrical tool. The stop cooperates for example with the carrier or carriers and prevents contact of the contact means with the counter contact means, if the battery voltage is equal to or lower than the nominal voltage. The charging unit preferably has a second blocking means, which can cooperate with the topography to employ a charging characteristic adapted to the battery pack, in particular for assuring a matching charging voltage and thus for preventing damage.

### SUMMARY OF THE INVENTION

The exemplary embodiment of the invention will be described in detail with reference to the following drawings, wherein:

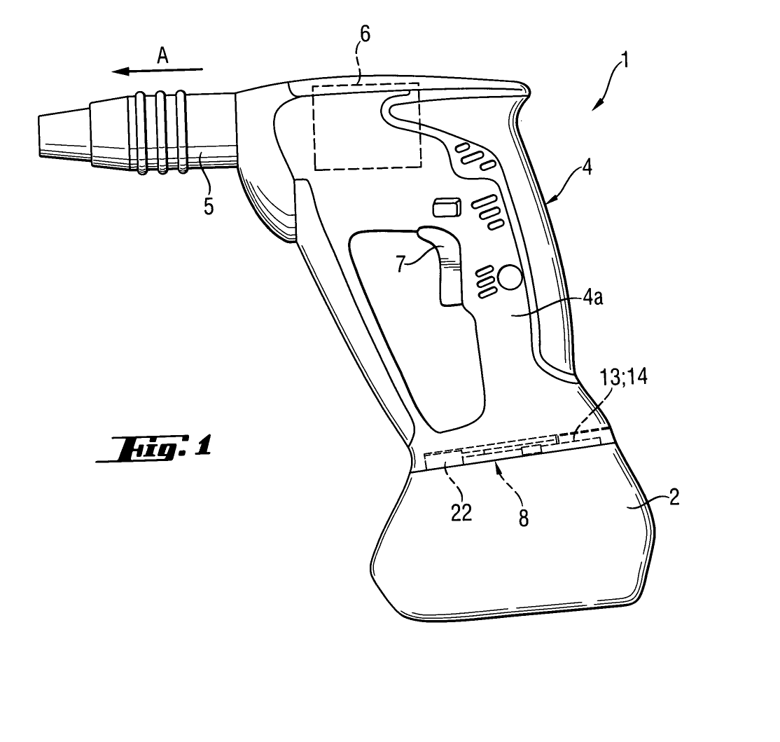

FIG. 1 shows a lateral view of an electrical tool system with an electrical tool and a battery pack in the receptacle, in accordance with the invention;

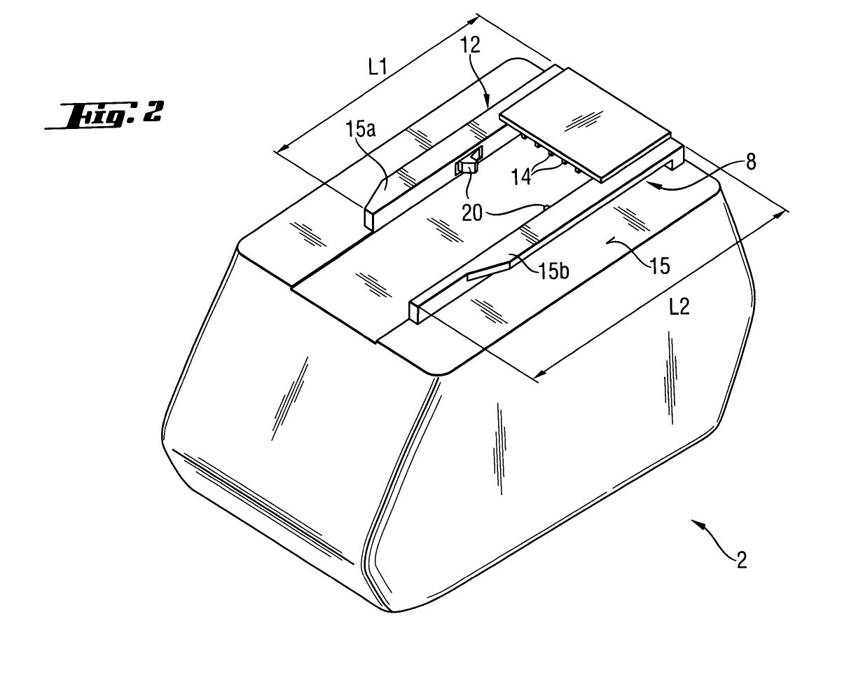

FIG. 2 shows a perspective view of the battery pack of FIG. 1;

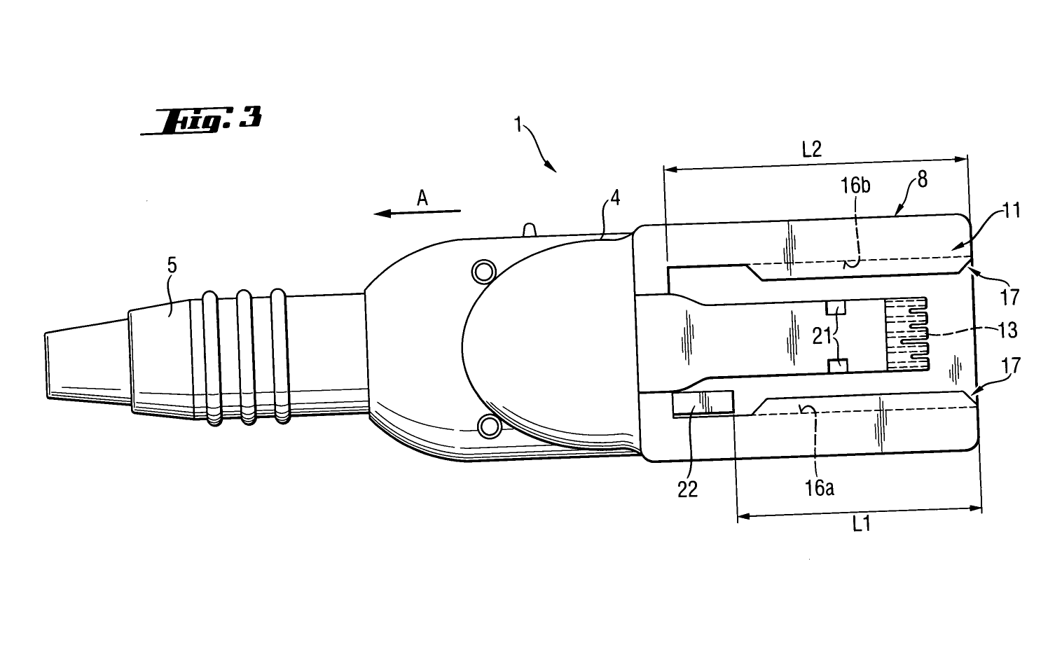

FIG. 3 shows a view from below of the electrical tool of FIG. 1; and

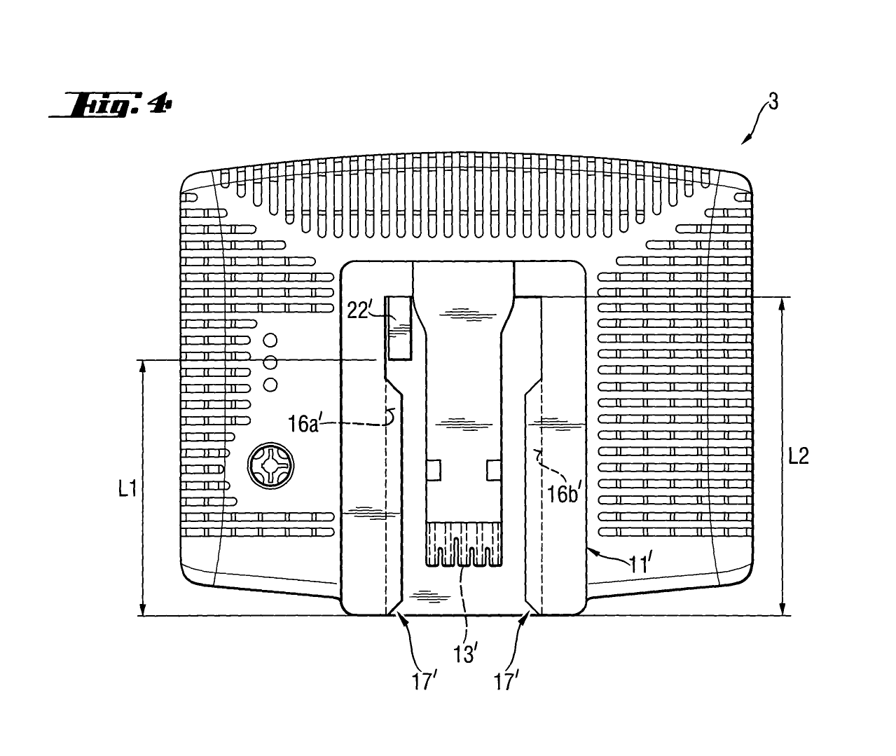

FIG. 4 shows a view onto a charging unit, in accordance with the invention.

### DETAILED DESCRIPTION OF THE INVENTION

FIG. 1 shows an electrical tool system, in accordance with the invention, having a battery pack 2 including a battery voltage; a charging unit 3 including a charging voltage for charging the battery pack 2; a hand-guided electrical tool 1 including a housing 4, in particular a screwdriver, and an attachment system 8 disposed on the housing 4 and on the battery pack 2 for detachable attachment of the battery pack 2 to the housing 4. The attachment system 8 on the housing 4 has a receiving member 11 and on the battery pack 4 has an engaging member 12, with which the receiving member 11 can interlock.

The electrical tool 1, as shown in FIG. 1, has a housing 4, a tool receptacle 5 and an electrical motor 6 that can be driven by the battery pack 2. The tool receptacle 5 is used for detachable attachment of a screwdriver bit (not shown), for example. An electrical switch 7 is disposed on the housing 4 for turning the electrical motor 6 on and off Additionally, as shown in FIG. 3, the housing 4 of the electrical tool 1 has a contact means 13 and the battery pack 2 has a corresponding counter contact means 14.

The battery pack 2, as shown in FIG. 2, has a cubical external contour. The engaging member 12 and the counter contact means 14 are arranged on the side 15 of the battery pack 2 facing the electrical tool 1. The engaging member 12 has two carriers 15a, 15b spaced apart from each other and running parallel to each other, which are configured L-shaped transverse to the longitudinal sense of the carriers 15a, 15b. In the interlock with the corresponding receiving member 11, the carriers 15a, 15b run parallel to the working direction A of the electrical tool 1, in particular the screwdriver. The carriers 15a, 15b project from the battery pack 2 transverse to its longitudinal sense and can be brought into locked contact with the receiving part 11, if the battery voltage of the battery pack 2 is the equal to or lower than the nominal voltage of the electrical motor 6.

The contact means 13 and the receiving part 11 are arranged on the free end of the housing 4 configured as the hand grip 4a, as shown in FIG. 3. The receiving part 11 has two recesses 16a, 16b running substantially parallel to the working direction A for receiving the corresponding carriers 15a, 15b. On the end on the working sense side of the longitudinally configured recesses 16a, 16b, these each have an opening 17 for introduction of the corresponding carrier 15a or 15b. In the inserted condition, the corresponding carrier 15a, 15b grips around the housing 4. The attachment system 8 preferably has a locking means to prevent unintended sliding out of the carriers 15a, 15b from the receiving part 11, in particular the recesses 16a, 16b. The locking means has, for example, two blocking tabs 20 disposed opposite each other, which are displaceably mounted transverse to the working direction A on the battery pack 2. In the inserted condition of the battery pack 2, each of the blocking tabs 20 engages through a corresponding opening 21 arranged on the housing 4.

The engagement member and the receiving means have a key device which has a topography on the battery pack 2 and a first blocking means on the housing 4, so that in the interlocked state the battery pack 2 and the electrical motor 6 cooperate if the battery voltage is equal to or lower than the nominal voltage. The carriers 15a, 15b of the battery pack 2 have the topography, wherein the topography includes the length L1 and L2 of the carriers 15a, 15b. The first blocking means has a stop 22 disposed in at least one recess 16a, 16b, which cooperates with the corresponding carrier or carriers 15a, 15b. In addition, the charging unit 3 has a second blocking means configured as a stop, which cooperates with the topography of the battery pack 2.

What is claimed is:

1. A hand-guided electrical tool system comprising a battery pack (2) having a battery voltage; a charging unit (3) having a charging voltage for charging the battery pack (2) and a hand-guided electrical tool (1) including one of a drill and screwdriver having an electrical motor (6) that can be driven at a nominal voltage by the battery pack (2); a housing (4); and an attachment system (8) disposed on the housing (4) and on the battery pack (2) for detachable attachment of the battery pack (2) to the housing (4), wherein the attachment system (8) has a receiving member (11) on one part and an engaging member (12) on another part that can be brought into engagement with the receiving member (11), wherein the housing (4) has a contact means (13) and the battery pack (2) has a corresponding counter contact means (14), wherein the engaging member (12) and the receiving member (11) each have a key device comprising a topography including a profile and a counter-topography including a counter profile for the topography, and wherein a nominal voltage of a system component (1, 2, 3) is associated with a specific topography and a complementary counter-topography.

2. The electrical tool system of claim 1, wherein the attachment system (8) comprises a blocking means that prevents engagement of the attachment system (8) between the electrical tool (1) and the battery pack (2) when the nominal voltage of the electrical tool (1) is lower than the battery voltage of the battery pack (2).

3. The electrical tool system of claim 1, wherein the battery pack (2) has the topography.

4. The electrical tool system of claim 1, wherein the battery pack (2) has at least one carrier (15a, 15b) with the topography.

5. The electrical tool system of claim 1, wherein the topography comprises a length (L1, L2) of carriers (15a, 15b) of the engagement member 12 .

6. The electrical tool system of claim 4, wherein the electrical tool (1) comprises a first blocking means.

7. The electrical tool system of claim 6, wherein the blocking means comprises at least one stop (22).

8. The electrical tool of claims 6, wherein the charging unit (3) comprises a second blocking means (22′), which can cooperate with the topography.
